(19) United States
(12) Patent Application Publication
(10) Pub. No.: US 2005/0221843 A1
(43) Pub. Date: Oct. 6, 2005

(54) Distribution of location specific advertising information via wireless communication network

(76) Inventors: Kimberley Friedman, Ft. Lauderdale, FL (US); Michael M. Anthony, Coral Springs, FL (US)

Correspondence Address: Mark D. Bowen;Stearns Weaver Miller, et al., Suite 1900, 200 East Broward Boulevard, Fort Lauderdale, FL, 33301, US

(21) Appl. No.: 10/812,427

(22) Filed: Mar. 30, 2004

(51) Int. Cl. H04Q 7/20

(52) U.S. Cl. 455/456.6; 455/457

(57) ABSTRACT

A system for displaying commercial advertising to a mobile unit via a wireless data communication with a global computer network, such as the Internet, based on GPS position data is disclosed. The system distributes location-relevant advertising content over a data network to a client based on a GPS position. A mobile electronic GPS enabled device communicates over a wireless link with a remote computer server and communicates GPS location information to the server. Upon receipt of the user's GPS location data, the server can then select to return to the user location specific commercial advertising information, thereby relieving the client of the task of filtering for relevant information. The commercial advertising information may include advertising of local interest, discount coupons accepted by businesses in the local vicinity of the user, and addresses and/or maps to local points of interest. The information may be received by vehicle mounted and/or hand-held electronic device. According to another aspect of the present invention, the system is useful in a search mode wherein information is relayed to the user based on “keywords” input by the user and GPS location information.

### COPYRIGHT NOTICE

A portion of the disclosure of this patent document contains material that is subject to copyright protection. The copyright owner has no objection to the facsimile reproduction by anyone of the patent document or patent disclosure, as it appears in the Patent and Trademark Office patent file or records, but otherwise reserves all copyrights.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

1. Field of the Invention

The present invention relates to a system and method for distributing location-relevant advertising information to a mobile user based upon the position of the user.

2. Description of the Background Art

The global positioning system (“GPS”) provides a system of satellites fixed in geostationary orbit that are capable of being used to obtain position information. A GPS receiver receives ranging signals from several GPS satellites, and triangulates these received ranging signals to obtain the measured position of the receiver. One application of GPS is vehicle location, however, the system is useful to provide navigational information in a wide variety of applications. For example, many vehicle manufacturers are incorporating GPS navigation systems adapted with moving map displays.

At the same time, a global computer network, commonly referred to as the Internet, has evolved. In the past few years the amount of commercial activity conducted over the Internet has increased dramatically allowing users of the Internet to access information anywhere in the world rapidly with a few keystrokes. Due to the large volume of information available over the Internet, however, users must often filter out a large amount of information in order to obtain relevant information of local interest.

Accordingly, there exists a need for a GPS-based system for determining the location of a user and displaying location specific commercial advertising to the user based on GPS acquired position information.

### BRIEF SUMMARY OF THE INVENTION

The present invention provides a system for displaying commercial advertising to a mobile unit via a wireless data connection with a global computer network, such as the Internet, based on GPS position data. According to a preferred embodiment, a system according to the present invention, distributes location-relevant advertising content over a data network to a client based on a GPS position. In one embodiment, a mobile electronic GPS enabled device communicates over a wireless link with a remote computer server and communicates GPS location information to the server. Upon receipt of the user's GPS location data, the server can then select to return to the user location specific commercial advertising information, thereby relieving the client of the task of filtering for relevant information. The commercial advertising information may include advertising of local interest, discount coupons accepted by businesses in the local vicinity of the user, and addresses and/or maps to local points of interest. The information may be received by vehicle mounted and/or hand-held electronic device.

According to another aspect of the present invention, the system is useful in a search mode wherein information is relayed to the user based on “keywords” input by the user and GPS location information. According to this embodiment, wireless two-way communications allow the user to transmit an information request using one or more “keywords” to a computer network whereby the computer network searches a database of available commercial information based relating to the keywords and the GPS coordinates of commercial advertisers are determined and relayed to the user. Thereafter, the location of the commercial advertisers may be displayed relative to the user on a moving map display such that the user is able to obtain directions to the location(s) of commercial outlets for the goods and/or services requested.

Accordingly, it is an object of the present invention to direct location specific commercial advertising information to mobile users via an electronic device.

Still another object of the present invention is to provide a wireless computer network wherein GPS enabled mobile units communicate with the network to obtain location specific information.

Still these and other objects will become apparent with reference to the detailed description below and the accompanying drawings.

### BRIEF DESCRIPTION OF THE SEVERAL VIEWS OF THE DRAWINGS

FIG. 1 illustrates information being relayed to receiver units via satellite;

FIG. 2 illustrates information being received by receiver units via satellite;

FIG. 3 illustrates an embodiment wherein commercial advertising is relayed to receiver units;

FIG. 4 illustrates a vehicle mounted receiver display;

FIG. 5 illustrates an embodiment wherein the GPS coordinates of specific advertisers are obtained using keyword searches;

FIGS. 6 and 7 are flow charts depicting the input of advertising information and delivery of same based on user input;

FIG. 8 illustrates the changing the delivery of advertising information provided to the user based on the user's location; and

FIG. 9 illustrates advertising information displayed on a remote electronic device.

### DETAILED DESCRIPTION OF THE INVENTION

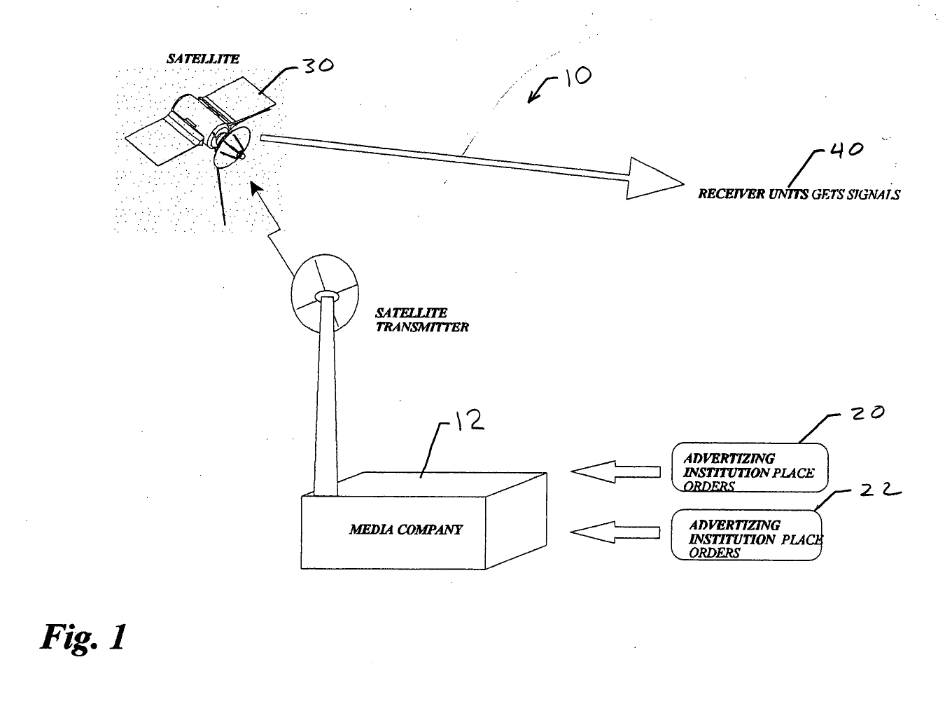

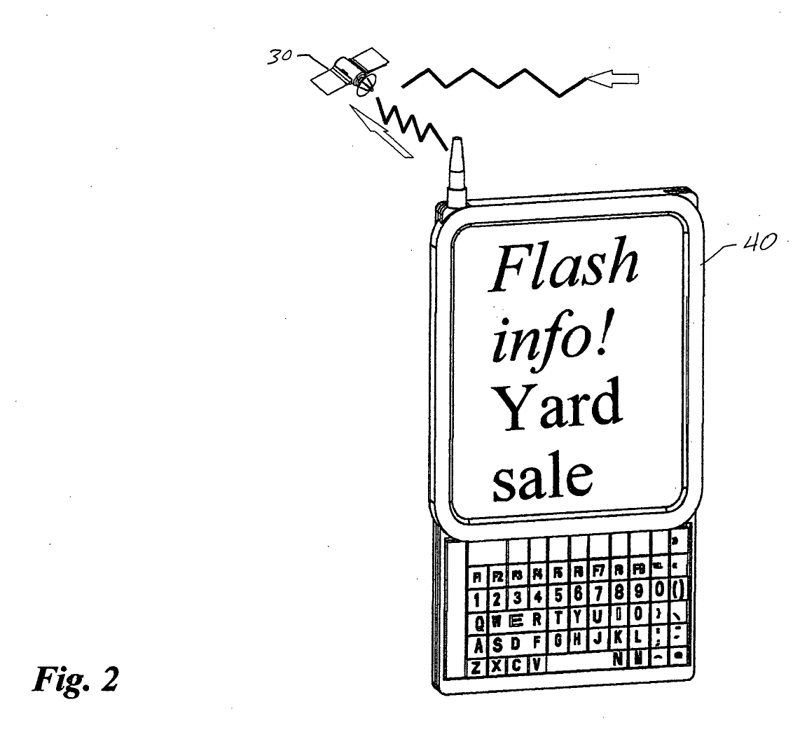

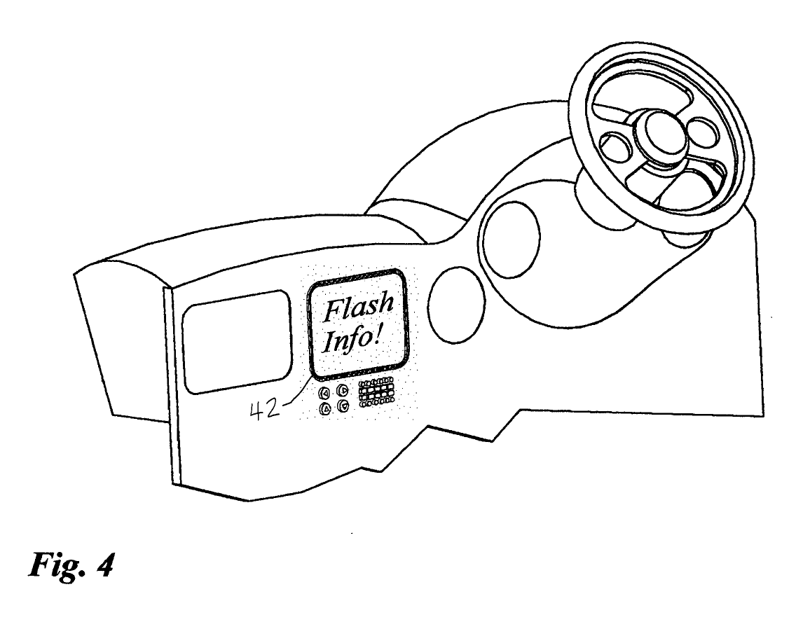

With reference now to the drawings, FIGS. 1-9 depict an information distribution system, generally referenced as 10, according to the present invention. FIG. 1 illustrates a system of the present invention wherein commercial advertising information is transmitted via wireless communications to remote GPS enabled receiver units. As seen in FIG. 1, advertising information is obtained by a computer network 12 preferably located at a media company from advertising sources, referenced as 20 and 22. The information is transmitted to a satellite 30 for relay to mobile remote wireless receiver units, referenced as 40. Mobile unit 40 may comprise a portable (e.g., handheld) electronic device as depicted in FIG. 2, or may comprise a mobile electronic device 42 installed in a vehicle as depicted in FIG. 4. Mobile units 40 and 42 each include a GPS receiver, a transmitter for transmitting messages to data network 12, and a data receiver for receiving messages from the data network.

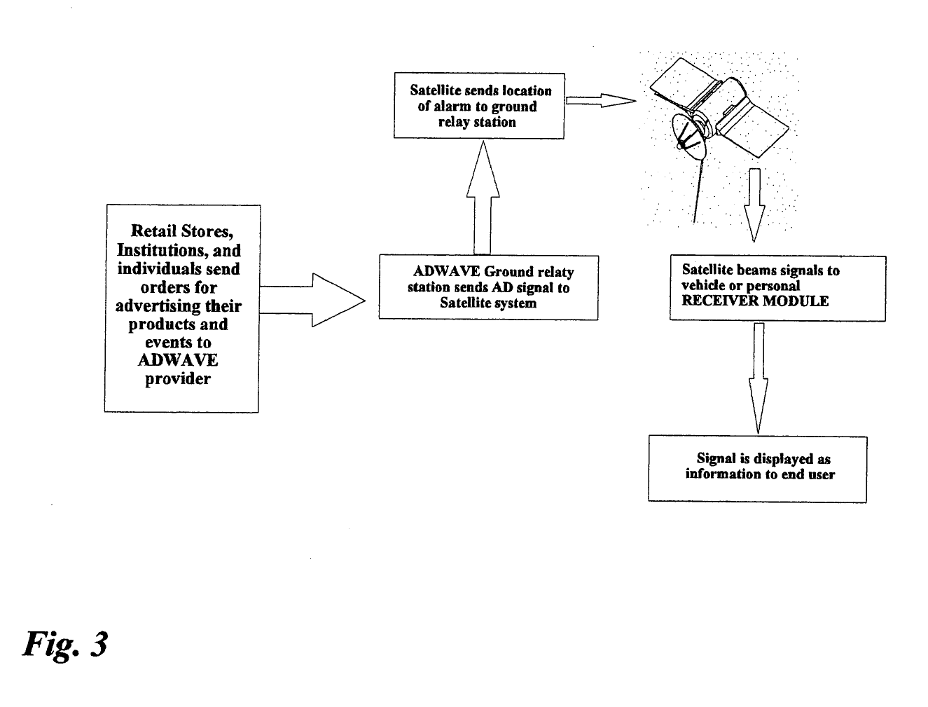

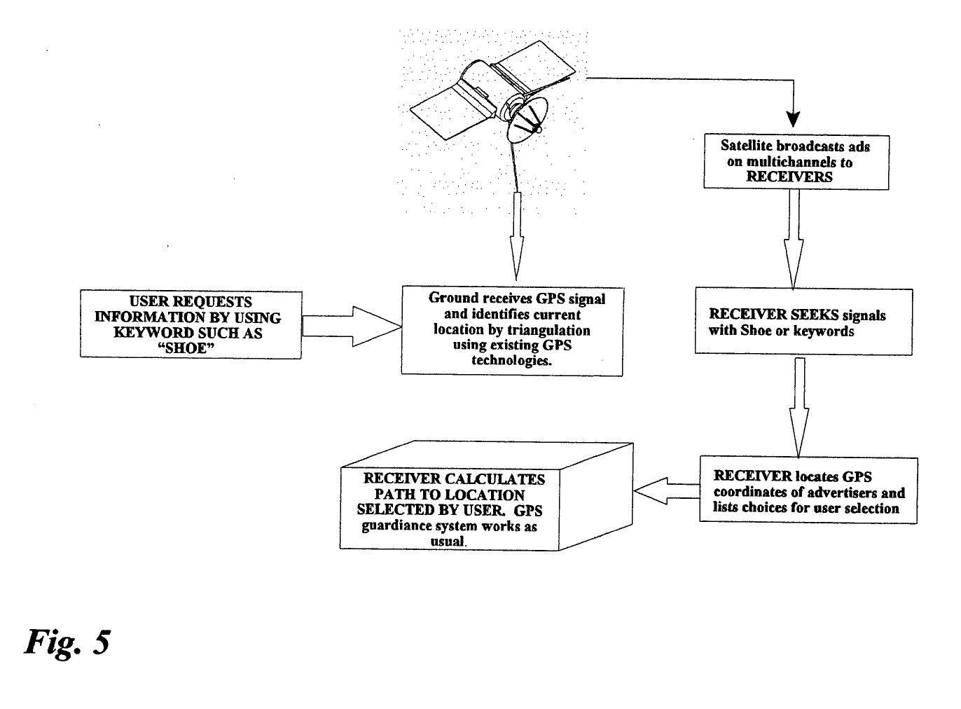

The mobile unit of the present invention allows a user to report its position and to obtain location specific information over a data network. In an embodiment wherein mobile unit 42 is adapted for use in a vehicle, the location specific information may include directions to a particular destination (e.g., a hotel, a gas station, or a restaurant). For example, using a GPS receiver, mobile unit 42 receives a positioning signal from GPS satellite constellation 30 and converts the signal into location coordinates. In a first mode of operation, mobile unit 42 may automatically receive via wireless communication link location specific advertising information. For example, as the mobile unit passes retail outlets that have subscribed and placed advertising information onto the network advertisements for said outlets automatically pop-up on the electronic display as illustrated in FIG. 3. In a second mode of operation, the user may input and send a query (e.g. “shoes”) using key words ad illustrated in FIG. 5. The query is received by the network and processed whereby the network broadcasts advertising information relating to the query (e.g. advertisements for shoe stores in proximity to the user). The second mode of operation further contemplates calculating the route to a selected location and displaying said route on a GPS enabled moving map display.

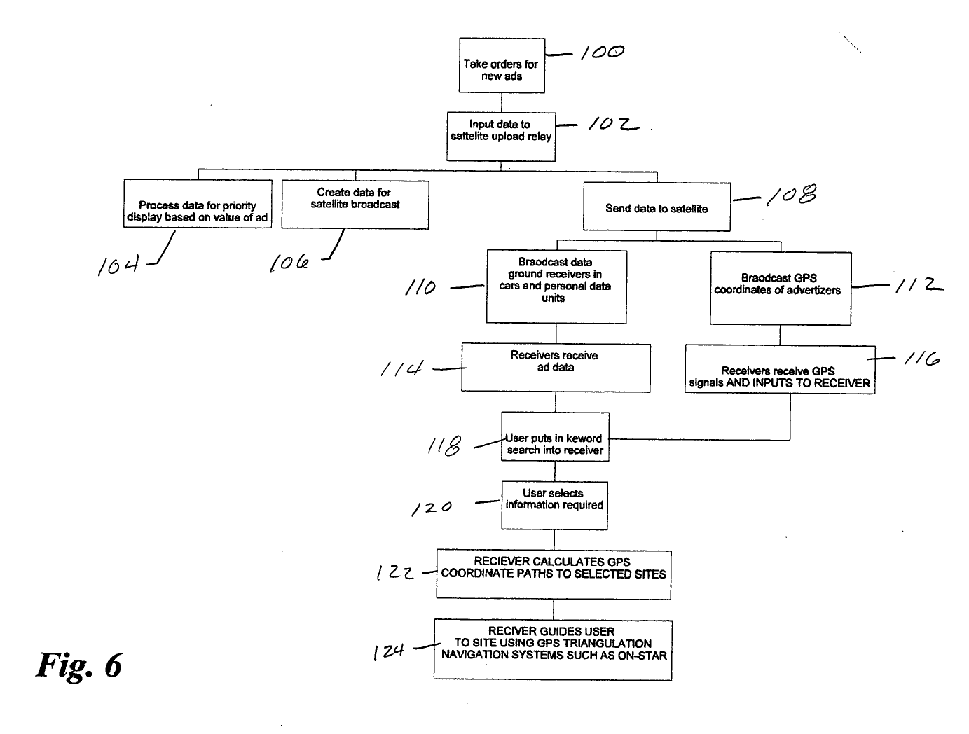

FIG. 6 illustrates a flow chart for information processed by the system. More particularly, starting at the top of the flow chart, block 100 represents the taking of orders for new advertising. Next, as represented by block 102 the data is input for satellite uploading. This process involves processing the data for priority display based on the value of the ad 104, creating data for satellite broadcast 106, and transmitting the data to a satellite 108. Satellite 108 may comprise a communications satellite, a GPS satellite, and/or a plurality of satellites may contribute to the communications depicted in FIG. 6. In any event, a satellite 108 broadcasts data to ground receivers 40 and 42, which data includes advertising data 110 and the GPS coordinates of advertisers 112. As further depicted in FIG. 6, receivers 40 receive the advertising data, as referenced by block 114, and the GPS signals as referenced by block 116. The receiver is preferably adapted to accept user input 118, such as a key word for searching (e.g. restaurants, gas, etc.). Based on the user input, the receiver matches the user request with information received from advertisers and presents the user with options 120. Receiver 40 then calculates the route to a selected commercial location 122, and displays the route on a moving map display 124.

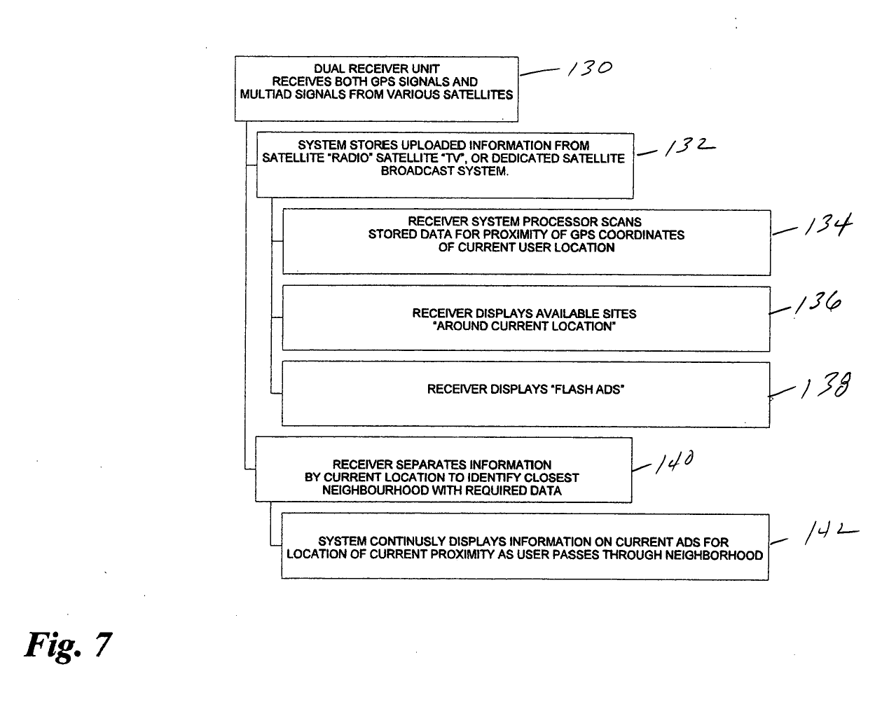

In the embodiment depicted in FIG. 7, a dual receiver unit, referenced by block 130 receives both GPS signals and advertising information from other communications satellites. As depicted by block 132, the system stores a variety of data that may be uploaded from various sources such as satellite radio, satellite TV, or a dedicated satellite broadcast system. As illustrated by block 134, the receiver system scans the stored data for advertisers having GPS coordinates in proximity to the receiver's GPS coordinates. Advertisers having locations in proximity to the receiver are displayed 136. In addition, the receiver may display “flash ads” as seen in block 138. A “flash ad” is advertising placed on the system by a company, and may highlight “sales”, “specials”, or any other information. As depicted in block 140, the receiver sorts the information by geographic location based on GPS data to identify the locations of the closest establishments capable of supplying the user's request. This information is continuously updated and displayed as the receiver passes through various geographic areas as depicted in block 142.

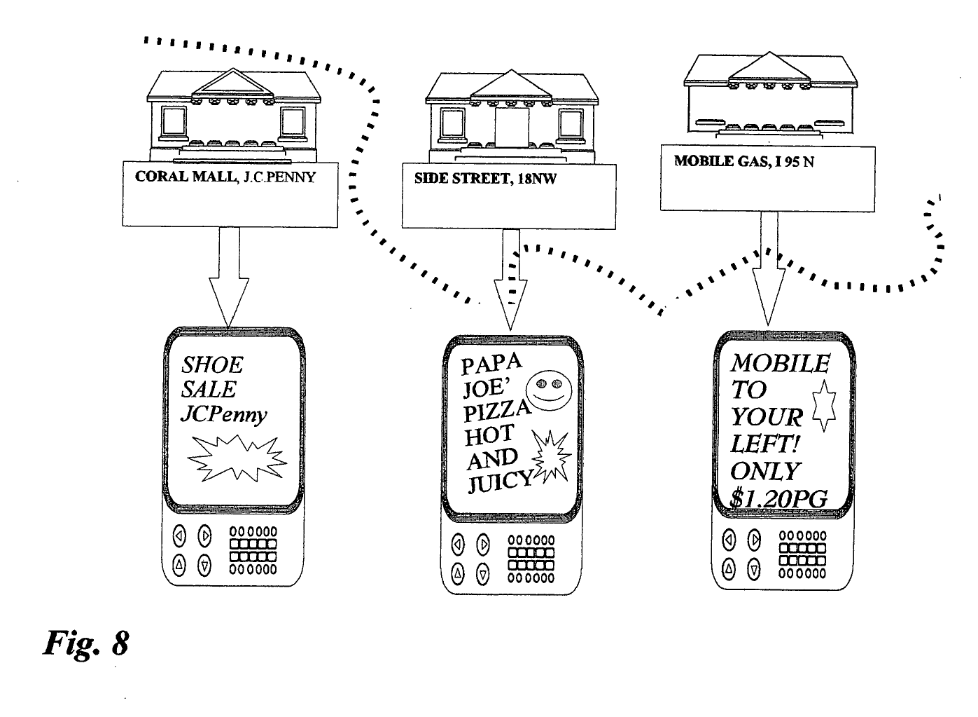

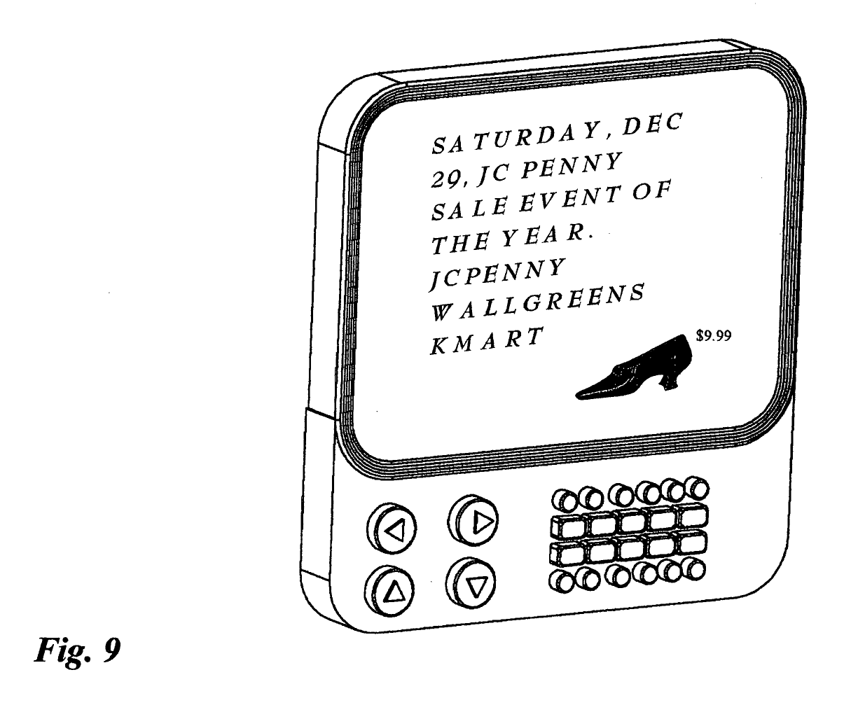

As best illustrated in FIG. 8, by tracking the location of a moving GPS-enabled receiver 40 and comparing the GPS coordinates, either alone and/or in combination with user input information (such as keywords), with GPS coordinates of commercial subscribers, advertising information for businesses that subscribe to the system may be presented to the user via electronic display. As should now be apparent, the advertising content displayed will automatically change as the location of the receiver unit changes. If the user has selected a particular input, such as “department stores”, receiver 40 will display advertising content and information relating to department stores in a pre-determined radius of the user. The user may also obtain additional information by selecting one of the displayed “department stores” whereby information particular to the selected store may be displayed as depicted in FIG. 9.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

1. A method for distributing location-relevant advertising information over a wireless communications network to a system user comprising:
obtaining advertising information from advertisers, said advertising information including advertising content and GPS coordinates;
storing said advertising information in a database;
transmitting said advertising information to a receiver over a wireless communications network, said receiver having an electronic display;
continually obtaining GPS coordinates of said at least one receiver;
comparing said receiver GPS coordinates with GPS coordinates contained in advertising information and determining proximity between said receiver GPS coordinates and advertising GPS coordinates; and
displaying advertising content for advertising information on said receiver electronic display based on proximity.

2. A method for distributing location-relevant advertising information according to claim 1, further including the steps of:
providing input to said receiver in the form of keywords;
comparing said keywords to keywords associated with said advertising information; and
displaying advertising content for advertising information on said receiver electronic display based on said input.

3. A method for distributing location-relevant advertising information according to claim 1, wherein said wireless communications network includes communications satellites.

4. A method for distributing location-relevant advertising information over a wireless communications network to a system user comprising:
obtaining advertising information from advertisers, said advertising information including advertising content and GPS coordinates;
storing said advertising information in a database;
charging said advertisers a recurring fee for storing and transmitting said advertising information;
transmitting said advertising information to a receiver over a wireless communications network, said receiver having an electronic display;
continually obtaining GPS coordinates of said at least one receiver;
comparing said receiver GPS coordinates with GPS coordinates contained in advertising information and determining proximity between said receiver GPS coordinates and advertising GPS coordinates;
displaying advertising content for advertising information on said receiver electronic display based on proximity; and
charging a receiver user a subscription fee for receiving said advertising information.

5. A method for distributing location-relevant advertising information according to claim 4, further including the steps of:
providing input to said receiver in the form of keywords;
comparing said keywords to keywords associated with said advertising information; and
displaying advertising content for advertising information on said receiver electronic display based on said input.

6. A method for distributing location-relevant advertising information according to claim 4, further including the step of prioritizing the display of advertising content based on fees paid by said advertisers.
